(19) United States
(12) Patent Application Publication
(10) Pub. No.: US 2023/0272884 A1
(43) Pub. Date: Aug. 31, 2023

(54) COMPRESSED NATURAL GAS (CNG) POWER SYSTEM WITH C02 EMISSIONS CAPTURE AND STORAGE

(71) Applicant: ECOLE POLYTECHNIQUE FEDERALE DE LAUSANNE (EPFL), Lausanne (CH)

(72) Inventors: Shivom SHARMA, SION (CH); François MARÉCHAL, SION (CH)

(21) Appl. No.: 18/023,309

(22) PCT Filed: Aug. 20, 2021
(86) PCT No.: PCT/EP2021/073103

§ 371 Date: Feb. 24, 2023

(30) Foreign Application Priority Data
Aug. 27, 2020 (EP) 20192988.2

(51) Int. Cl. F17C 13/00

(52) U.S. Cl. CPC F17C 13/002; F17C 2270/0184; F17C 2201/0185; F17C 2201/0109; F17C 2205/0326; F17C 2221/013; F17C 2221/033; F17C 2223/0123; F17C 2227/0157; F17C 2227/0309; F17C 2270/0171; F17C 2270/0176

(57) ABSTRACT

CNG power system (1) comprising a storage tank (6) connected fluidically to a fuel conversion system (2) via an energy transfer system (4), the fuel conversion system (2) comprising a power unit using CNG as fuel and generating gas emissions comprising CO2, the fuel conversion system comprising a CO2 capture unit (16) configured for separating out CO2 from the gas emissions. The energy transfer system comprises a CNG expansion turbine (22) mounted in a fuel circuit (8) between the storage tank and fuel conversion system powered by expansion of the CNG flowing from the storage tank to the fuel conversion system, and a CO2 compressor (24) connected between the fuel conversion system and the storage tank along a CO2 circuit (10) for compressing the CO2, power for driving the CO2 compressor (24) being supplied in part by power generated by the CNG expansion turbine (22).

### FIELD OF THE INVENTION

This invention relates to a compressed natural gas (CNG) power system incorporating a CNG power unit and a system for capture and storage of CO₂ emissions from the CNG power unit, especially for mobile applications. The mobile applications include in particular power units for trucks, buses and other large vehicles.

### BACKGROUND OF THE INVENTION

Among the challenges of the energy transition, reducing CO₂ emissions of the transportation sector is one of the most difficult. In order to reduce the CO2 emissions in transportation sector, there are options like increase the efficiency of the power train, electrify at different levels, and change the CO2 emissions of the fuel. For short range vehicles, the solution is typically the use of a full electric power train, this is however penalized by the weight of the batteries. The energy densities of batteries is much lower compared to the hydrocarbon fuels (e.g., diesel, compressed natural gas). Electric vehicles have limited autonomy, and they have to be charged frequently that may take hours (Rogge et al., 2015). Around the world, many manufacturers are showing great interest in the electric vehicles development. In 2018, there were about 460 thousands electric buses globally (Global EV Outlook, 2019). For full electric power train system, the electricity can be supplied from the renewable sources. However one has to recognize that due to the intermittent nature of the source, there will be need of robust grid management system. At a certain threshold, there is a need to use chemical storage system, being hydrogen or hydrocarbon fuel.

For long range vehicles, liquid or gaseous fuels are used in internal combustion engine to supply the shaft power. Further, on-board fuel cells can be used on electric vehicles to increase their autonomy. This arrangement can increase the driving range of vehicles, and make it comparable with the traditional vehicles with internal combustion engines (Dimitrova and Maréchal, 2016). Solid oxide fuel cell (SOFC) has high fuel to electricity conversion efficiency (Sharma and Maréchal, 2018). The electricity produced by fuel cell is directly used to drive the vehicle, and balance electricity is used for charging of on-board batteries. This arrangement avoids battery charging losses (12%; Iosifidou et al., 2017), and also reduces on-board battery capacity or weight.

Compressed natural gas (CNG) is an attractive solution among the hydrocarbon fuels. It has been proposed to reduce the emissions in the transportation sector, as it can be produced from renewable energy sources. The average energy consumption of an electric bus is about 175 kWh for 100 km. With 75% conversion efficiency of SOFC system, electric bus requires about 233.3 kWh fuel energy for 100 km travel. On the other hand, traditional diesel bus consumes about 552 kWh fuel energy for 100 km travel (Gao et al., 2017). Energy consumption by a traditional CNG bus (with internal combustion engine: ICE) is about 24% higher compared to a traditional diesel bus (Lajunen and Lipman, 2016). In future, on-board fuel cells using CNG as fuel are expected to be used in the transportation sector. CNG may be used as on-board energy source for internal combustion engine or hybrid electric (SOFC with batteries) vehicle. CNG is typically stored on vehicles at 200 bar, and is depressurized to a lower pressure before using in an internal combustion engine or a SOFC.

An internal combustion engine produces exhaust gases, whereby 90% of the produced CO2 can potentially be captured on-board with a low energy penalty using turbocompressors and a temperature swing adsorption system as described in Sharma and Maréchal, 2019. Nevertheless, the system is somewhat complex and there is a continuous desire to find economical solutions for CO2 capture and onboard storage in vehicles. SOFC also produces CO2 as a side product, however the aforementioned system cannot be used in this case and the energy penalty for CO2 storage is high.

### SUMMARY OF THE INVENTION

An object of the invention is to provide a compact and energy efficient system for the onboard capture and storage of CO2 in vehicles having compressed natural gas (CNG) as an energy source.

It is advantageous to provide an economical system for the onboard capture and storage of CO2 in vehicles having compressed natural gas (CNG) as an energy source.

It is advantageous to provide a lightweight and compact system for the onboard capture and storage of CO2 in vehicles having compressed natural gas (CNG) as an energy source.

Objects of this invention have been achieved by providing the system according to claim 1.

Advantageously, in the present invention, energy of the compressed natural gas (CNG) is used to compress the CO2 generated by the reaction of the CNG and to store the generated CO2 in the CNG reservoir. The main idea is to use the energy from expansion of the CNG to compress the captured CO2 and store it in the same storage tank with a movable wall or membrane. In this case, the captured CO2 does not create any volume penalty on the vehicle, and avoids weight of a separate tank to store CO2. The pressure of CNG storage tank dynamically changes with the consumption of CNG, and about half of the CO2 compression power can be supplied by the depressurization of CNG.

Disclosed herein is a CNG power system comprising a storage tank, a fuel conversion system and an energy transfer system, wherein the storage tank is connected fluidically to the fuel conversion system via the energy transfer system, the fuel conversion system comprising a power unit using CNG as fuel and generating gas emissions comprising CO2, the fuel conversion system comprising a CO2 capture unit configured for separating out CO2 from the gas emissions. The energy transfer system comprises a CNG expansion turbine mounted in a fuel circuit between the storage tank and fuel conversion system powered by expansion of the CNG flowing from the storage tank to the fuel conversion system, and a CO2 compressor connected between the fuel conversion system and the storage tank along a CO2 circuit for compressing the CO2, power for driving the CO2 compressor being supplied in part by power generated by the CNG expansion turbine.

In an advantageous embodiment, the storage tank comprises a CNG section in which CNG is stored and a CO2 section in which captured CO2 is stored, the CNG section separated from the CO2 section by a movable partition.

In an advantageous embodiment, the partition is a movable wall within the storage tank, or a deformable membrane substantially hermetically sealing the CNG section from the CO2 section.

In an advantageous embodiment, the energy transfer system further comprises heat exchangers configured for transferring heat from the CO2 circuit to the fuel circuit.

In an advantageous embodiment, the heat exchangers comprise at least a first heat exchanger coupled to the CO2 circuit upstream of the CO2 compressor and downstream of the CNG expansion turbine.

In an advantageous embodiment, the energy transfer system comprises a second heat exchanger connected upstream of the CNG expansion turbine and downstream of the CO2 compressor.

In an advantageous embodiment, the storage tank is connected to the fuel circuit via a first flow control valve and to the CO2 circuit via a second flow control valve.

The power unit may comprise an internal combustion engine or a solid oxide fuel cell SOFC or a hybrid system including both an internal combustion engine and a SOFC.

Further objects and advantageous aspects of the invention will be apparent from the claims, and from the following detailed description and accompanying figures.

### BRIEF DESCRIPTION OF THE DRAWINGS

The invention will now be described with reference to the accompanying drawings, which by way of example illustrate embodiments of the present invention and in which:

FIG. 1a is a graph illustrating a change in volume, in the present example (solid oxide fuel cell) defined by a non-linear displacement of a partition inside the storage tank, based on CNG and CO2 moles (total 6 moles; Length-storage tank length on CNG side);

FIG. 1b is a graph illustrating the mechanical power generated by CNG (0.1 moles) depressurization from the storage tank pressure to a pressure of 1 bar, and the power required to compress CO2 (0.1 moles) from 1 bar to the storage tank pressure (solid oxide fuel cell);

FIG. 2 is a schematic block diagram of a CNG power system according to an embodiment of the invention;

FIG. 3a is a graph illustrating the power required to compress CO2 from 1 bar to tank pressure, and compression power supplied by CNG expansion from tank pressure to 1 bar (3-stages) for a CNG system with a solid oxide fuel cell (SOFC);

FIG. 3b is a schematic block diagram of a CNG power system according to an embodiment of the invention with a SOFC;

FIG. 4a is a graph illustrating a change in volume, in the present example (an internal combustion engine) defined by a non-linear displacement of a partition inside the storage tank, based on CNG and CO2 moles, of the embodiment of FIG. 5b;

FIG. 4b is a graph illustrating the mechanical power generated by CNG (0.1 moles) depressurization from the storage tank pressure to a pressure of 5 bar, and the power required to compress CO2 (0.09 moles) from 1 bar to the storage tank pressure, of the embodiment of FIG. 5b (an internal combustion engine);

FIG. 5a is a graph illustrating the power required to compress CO2 from 1 bar to tank pressure, and compression power supplied by CNG expansion from tank pressure to 1 bar (3-stages) for a CNG system an internal combustion engine (ICE);

FIG. 5b is a schematic block diagram of a CNG power system according to an embodiment of the invention with an ICE.

### DETAILED DESCRIPTION OF EMBODIMENTS OF THE INVENTION

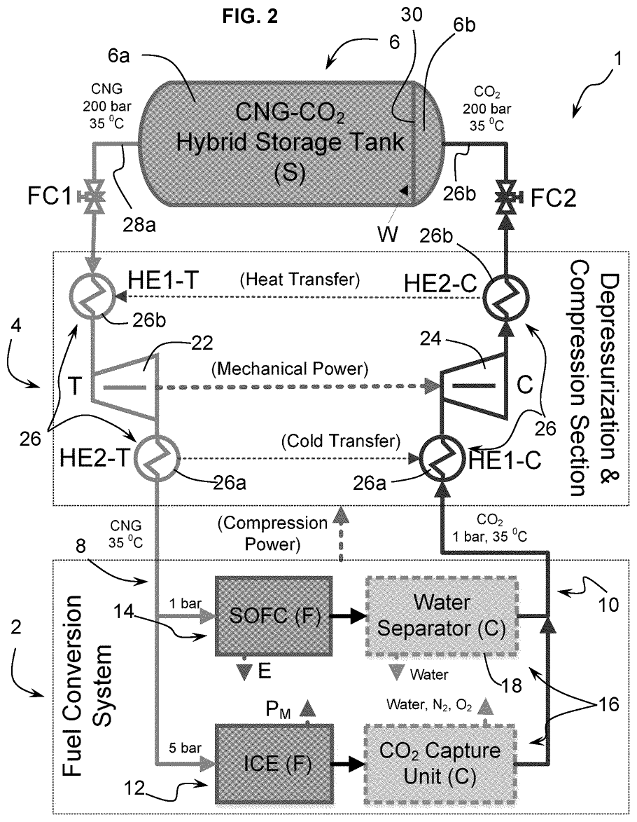

Referring to the figures, in particular FIG. 2, a compressed natural gas (CNG) power system 1 according to an embodiment of the invention comprises a fuel conversion system 2, an energy transfer system 4, and a storage tank 6 fluidically connected to the energy transfer system 4 via a fuel circuit 8 and a CO2 circuit 10. The fuel conversion system comprises a power unit that may have an internal combustion engine (ICE) 12 or a solid oxide fuel cell (SOFC) 14, or both an internal combustion engine and a solid oxide fuel cell. The fuel conversion system 2 further comprises a carbon dioxide (CO2) capture unit 16 connected fluidically to the internal combustion engine 12 or solid oxide duel cell 14 configured to collect the gas emissions therefrom and to extract the CO2 from the gas emissions.

In a case of a SOFC 14, the emissions are principally constituted of water and CO2, the CO2 capture unit comprising a water separator, for instance in form of a condenser, to separate the water vapor out of the emissions. In a case of an internal combustion engine 12, the CO2 capture unit separates water, nitrogen and oxygen from the emissions to output the CO2 emission into the CO2 circuit 10. The CNG is provided as an input to the power unit from the fuel circuit 8.

The storage tank 6, according to the invention, comprises a CNG section 6a in which the CNG fuel is stored, and a CO2 section 6b in which the captured CO2 is injected and stored, the CNG section 6a is separated from the CO2 section 6b by a partition 30. The partition 30 is configured to allow the gas pressure between the two sections 6a, 6b to be transmitted such that the CO2 stored in the CO2 sections and the CNG stored in the CNG section are essentially at the same pressure within the storage tank. The partition may take various forms for instance may be in a form of a movable wall e.g. in the form of a sliding piston between the two sections, or in a form of an elastic or collapsible membrane impermeable or substantially impermeable to the transfer of gas. The movable partition allows the volume of the CNG section 6a with respect to the CO2 section 6b to vary between a minimum value for instance in a range of 0 to 10% of the total volume of the storage tank, to a maximum value for instance in a range of 90 to 100% of the total storage tank volume. Thus, as CNG is consumed by the power plant and CO2 emissions are captured, the CNG section reduces in volume and the CO2 section increases correspondingly in volume.

Advantageously, a single storage tank may thus be used for the storage of the CNG fuel and also for the captured CO2 such that a separate storage tank for the CO2 emitted by the power unit is not required. It may be noted that a vehicle may comprise more than one CNG storage tank whereby each of these may advantageously be provided with a CO2 storage section.

The CNG section 6a is fluidically connected to the fuel circuit 8 via a flow control valve FC1 exiting the storage tank through an entry/exit connection 28a. the CO2 section 6b is connected to an entry/exit connection 28b to the CO2 circuit 10 via a flow control valve FC2. The energy transfer system 4 is connected between the storage tank 6 and the fuel conversion system 2. An electronic control system may be connected to the flow control valves and to one or more pressure sensors to control CNG and CO2 flows in the circuit.

The energy transfer system 4, which comprises a depressurization section and compression section, comprises a CNG expansion turbine device 22 and a CO2 compressor 24. When CNG flows, it drives the turbine as the CNG gas expands and drops in pressure. The energy collected from the CNG expansion driving the turbine 22 may be used to supply power to the CO2 compressor 24, either by a direct mechanical connection or by an indirect power transfer, such as charging of a battery or other potential energy source. The remaining energy required to drive the CO2 compressor 24 may be supplied by the power unit, here also either by direct mechanical coupling by an electrical or other form of motor supplied with energy by the fuel conversion system 2. The CO2 compressor 24 is connected fluidically along the CO2 circuit 10 to the output of the fuel conversion system CO2 capture unit 16 and connected upstream to the CO2 section 6b of the storage tank 6.

The energy transfer system advantageously further comprises one or more heat exchangers 26, for instance a first heat exchanger 26a connected between the fuel circuit 8 downstream of the expansion turbine 22 and the CO2 circuit 10 upstream of the compressor 24, and a second heat exchanger 26b in a fuel circuit 8 upstream of the expansion turbine 22 and downstream of the compressor 24, such that heat may be transferred from the CO2 circuit 10 to the fuel circuit 8.

The CO2 gas that is captured from the power unit is thus cooled; the heat being used to heat the expanding CNG gas. The transfer of mechanical energy between the fuel circuit 8 and CO2 circuit 10 and heat energy between the CO2 circuit to the fuel circuit thus results in a high energy efficiency for the CO2 capture and storage.

CNG Storage Tank

In vehicles using CNG as a fuel, the CNG is typically stored in a pressurized reservoir at 200 bar at 35C (Ashok Leyland Report, 2002).

In order to control the air pollution in cities, CNG buses are widely used in several countries. The typical capacity of CNG storage tank for bus application is about 6 kmoles CNG (or 100 kg; Krelling and Badami, 2016). It is assumed that natural gas contains 98% methane and remaining CO2. The pressure of CNG storage tank decreases with the consumption of CNG. The power unit converting CNG can be according to various embodiments an internal combustion engine or a SOFC as mentioned above. In both cases on-board capturing and storing CO2 is advantageous to reduce CO2 emissions and render the use of CNG fuelled vehicles an attractive option to other forms of power generation, especially if the energy penalty related to CO2 capture is mitigated and on-board CO2 storage is rendered compact and lightweight as proposed in the present invention by filling the captured CO2 into the storage tank also used for the CNG. When using CNG fuel, one mole of methane can be replaced by one mole of captured CO2. At the CNG filling station, CNG can be refilled in the storage tank, and compressed CO2 can be discharged for renewable methane production (using renewable energy) or underground sequestration.

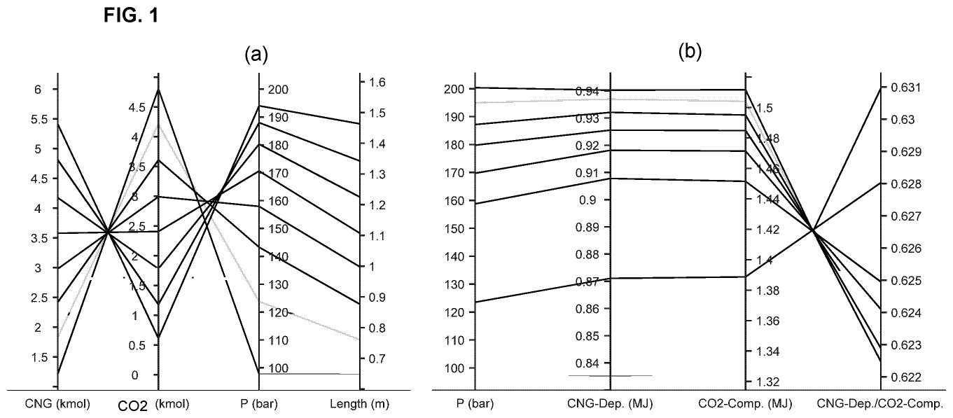

Embodiments of the invention thus avoid volume and weight penalties for a separate storage tank for captured CO2. By way of example, 6 kmoles of CNG at 200 bar and 35 C has a volume of 0.7686 m3. The dimensions of a cylindrical CNG-CO2 hybrid storage tank would for instance comprise a length of 1.576 m, and a diameter of 0.788 m. With the consumption of CNG in a vehicle power system, the volume of CNG in the storage tank decreases, while the volume of captured CO2 in the storage tank increases. Hence, the movable partition inside the hybrid storage tank moves, whereby for a constant rate of CNG consumption by the vehicle power system, the initial movement of the partition (at high pressure of storage tank) is slow compared to the movement of the partition at a low pressure of the storage tank, as illustrated in FIG. 1(a). Further, the pressure of the storage tank decreases with CNG consumption by the power system.

The mechanical power generated by CNG expansion is used to compress product CO2. The CNG fuel is depressurized from the storage tank pressure to the pressure of gas input into the power unit pressure (e.g. 1 bar for SOFC).

The mechanical power generated by CNG expansion, using a turbine for instance with 85% energy conversion efficiency, depends on the storage tank pressure. Further, the CO2 produced from vehicle fuel conversion system has to be compressed, for instance using a compressor with 80% energy conversion efficiency, to the storage tank pressure. FIG. 1(b) illustrates an example of the mechanical power generated by CNG (0.1 moles) expansion from the storage tank pressure to 1 bar, and compression of emitted CO2 (0.1 moles) from 1 bar to storage tank pressure. It can be seen in this example that 62.2 to 63.1% of mechanical power required for CO2 compression can be supplied by the CNG expansion.

Main features of the invention may be summarized as follows:
The power unit of the fuel conversion system converts the natural gas from the storage tank in energy services such as electricity, heating or cooling, and has an integrated CO2 capture unit. The power unit can be for example an internal combustion engine or a solid oxide fuel cell.
The storage tank contains a compartment with compressed natural gas (CNG) at high pressure.
The CO2 captured from the fuel conversion system is compressed and stored in the CO2 compartment of the storage tank. A movable hermetic partition divides the storage tank into two compartments. The movement of the partition depends upon the CNG and CO2 quantities in the storage tank. It is a function of the natural gas consumption in the conversion unit and CO2 capture rate. Pressure of the storage tank results from the volumetric balance.
If an internal combustion engine is used as the power unit of the fuel conversion system, then the CO2 capture unit is configured to separate CO2 from N2, O2 and H2O. If a solid oxide fuel cell is used for the power unit of the fuel conversion system, then the CO2 capture unit is configured to separate CO2 from H2O.
In order to generate mechanical power by CNG expansion, the CNG expansion turbine may comprise multi-stage micro-turbines and in addition with heat exchangers to increase energy efficiency by transferring heat generated by compression of the CO2 to the CNG under expansion. The generated mechanical power from the CNG expansion turbine may be used directly by a mechanical coupling for the CO2 compression, or indirectly, for instance by driving an electrical generator for conversion into electrical energy.
The emitted CO2 from the fuel conversion system at low pressure (about 1 bar) is compressed to storage tank pressure by the CO2 compressor, which may advantageously comprise multi-stage micro-compressors and in addition with heat exchangers to increase energy efficiency by transferring heat generated by compression of the CO2 to the CNG under expansion.
The mechanical power generated by turbine and supplied to the compressor may typically comprise in a range of 60-65%, more particularly 62.2-63.1% of the total power need for the CO2 compression, whereby the remaining CO2 compression power may be supplied by the fuel conversion system.
Flow control valves on both the CNG and CO2 circuit portions may be used to regulate the flows of CNG and emitted CO2 between the fuel conversion system and storage tank. The pressure of the storage tank changes with the consumption of CNG and production of CO2. Hence, an electronically controlled system may be connected to the flow control valves and to one or more pressure sensors to control CNG and CO2 flows in the circuit.

Additional advantageous features may include:
At a CNG filling station, the functionality of the energy transfer system (i.e. the depressurization and compression section) can advantageously be reversed. The natural gas from filling station has to be compressed and stored in the vehicle storage tank, whereas CO2 from vehicle storage tank has to be expanded and used in a methanation reactor.
In case of SOFC conversion system, SOFC can be used as SOEC (solid oxide electrolyser cell) system to convert on-board CO2 directly into green natural gas, using renewable electricity in the parking lot. Mechanical power generated by CO2 expansion can be used to compress green natural gas to the hybrid storage tank pressure.
Steady-state operation of SOFC can be maintained, by using on-board low capacity battery as buffer.
In case of internal combustion engine, a CO2 capture technology (absorption, pressure swing adsorption, temperature swing adsorption, membranes, etc.) can be integrated for capturing CO2 from exhaust gases.

Case Studies

Solid Oxide Fuel Cell System

This case study considers 200 km travel by a CNG city-bus, with on-board SOFC system and a small capacity battery. Here, 10 hours travel time has been assumed to travel this distance. In order to fulfill the electricity demand of the bus motor, the on-board SOFC system should produce 350 kWh electricity.

Since SOFC system can operate for 10 hours, it should generate 35 kWh electricity, each hour. Hence, the power output of the SOFC system should be 35 kW, to satisfy the electricity demand of the bus motor. The SOFC model has been developed in Belsim VALI flowsheeting software (Sharma and Maréchal, 2018).

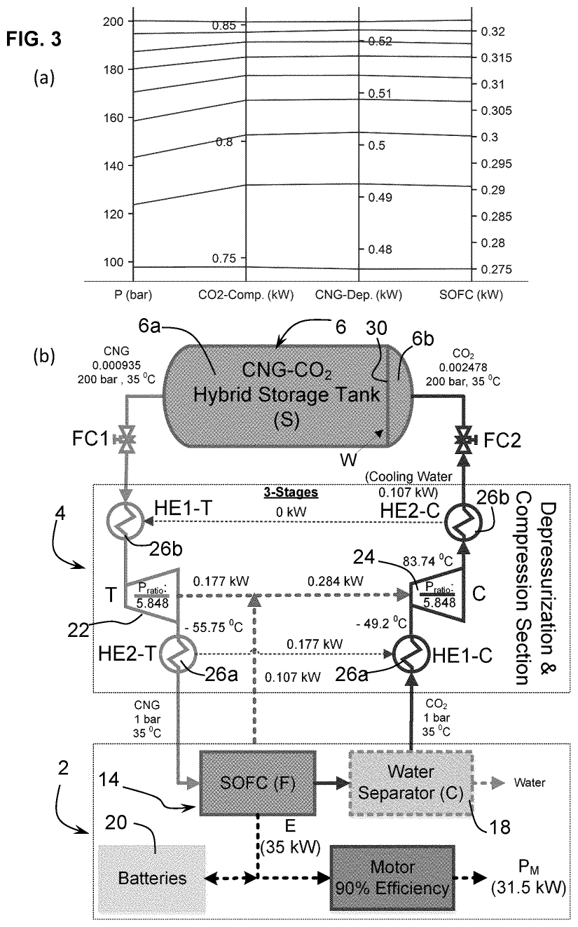

The design and operation of a typical SOFC system is generally optimized for maximization of first law efficiency and minimization of total capital cost. In order to perform heat integration, a heat cascade model (Maréchal and Kalitventzeff, 1998) has been used. An optimum solution has for instance a first law efficiency of 0.792. Considering for example a 35 kW power output, about 0.000935 kg/s of natural gas is consumed by the SOFC system. In this example, the SOFC system produces about 0.002478 kg/s of CO2 that should be compressed to storage tank pressure. Part of the CO2 compression power is supplied by the CNG expansion turbine and the remaining part is supplied by the SOFC system (it will consume additional CNG fuel). FIG. 3(a) illustrates, for this example, the power generated by CNG expansion (0.000935 kg/s) from different storage tank pressures to 1 bar, and the power required for compressing CO2 (0.002478 kg/s) from 1 bar to different storage tank pressures. FIG. 3(a) also shows additional power supplied by SOFC system to compress CO2. In this example, the total power required for compressing CO2 varies between 0.746 to 0.852 kW, depending on storage tank pressure. More than 62% of compression power can thus be supplied by CNG expansion from different storage tank pressures to 1 bar. The remaining compression power (0.275 to 0.322 kW) is supplied by fuel conversion system.

FIG. 3(b) illustrates an embodiment of the invention that includes a SOFC power unit. The energy penalty for CO2 compression, in terms of extra CNG-used, is negligible compared to CNG-used to generate electricity to drive the bus motor or charge on-board batteries. FIG. 3(b) illustrates flow-rates, temperatures, pressures and energy values corresponding to a 200 bar storage tank pressure. These values will change with storage tank pressure (i.e., the consumption of CNG), and can be obtained using data provided in FIGS. 1 and 3(a).

Internal Combustion Engine

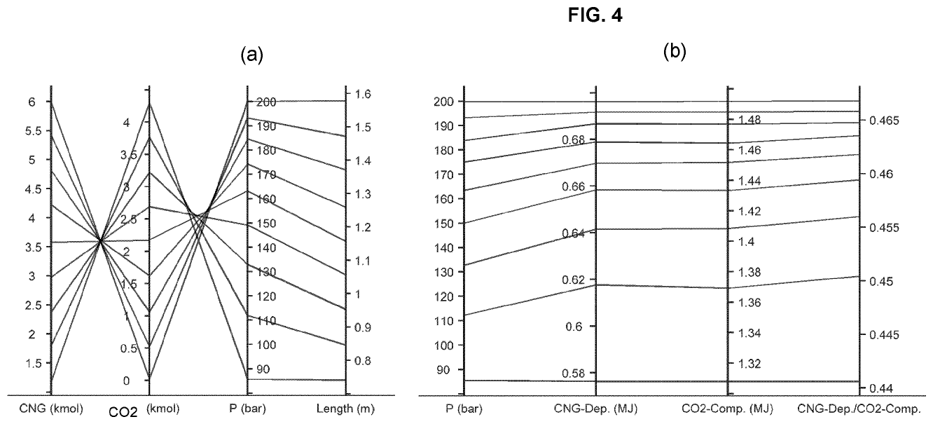

For a conventional CNG vehicle, 5 bars is the typical minimum pressure at the inlet of the internal combustion engine. Hence, a lower amount of mechanical power can be extracted by CNG expansion, for an internal combustion engine conversion system than for a SOFC conversion system. In case of an internal combustion engine, a CO2 capture technology should be integrated for capturing CO2 from the exhaust gases. It is known from Sharma and Maréchal (2019) that a temperature swing adsorption based CO2 capture system can capture 90% CO₂ with little or no energy penalty. As 10% CO₂ is lost to the environment, total moles of CNG and CO2 in the storage tank decreases with the consumption of CNG in the internal combustion engine. FIG. 4(a) presents CNG moles, CO2 moles, storage tank pressure and movement of wall inside the storage tank.

The mechanical power generated by CNG expansion (using in this example a turbine with 85% efficiency) is used to compress product CO2 (using in this example a compressor with 80% efficiency). FIG. 4(b) presents mechanical power generated by CNG (0.1 moles) expansion from storage tank pressure to 5 bar, and compression of product CO2 (0.09 moles) from 1 bar to storage tank pressure. It can be seen that 44.1 to 46.7% of mechanical power required for CO2 compression can be supplied by the CNG expansion. The remaining CO2 compression power should be supplied by ICE.

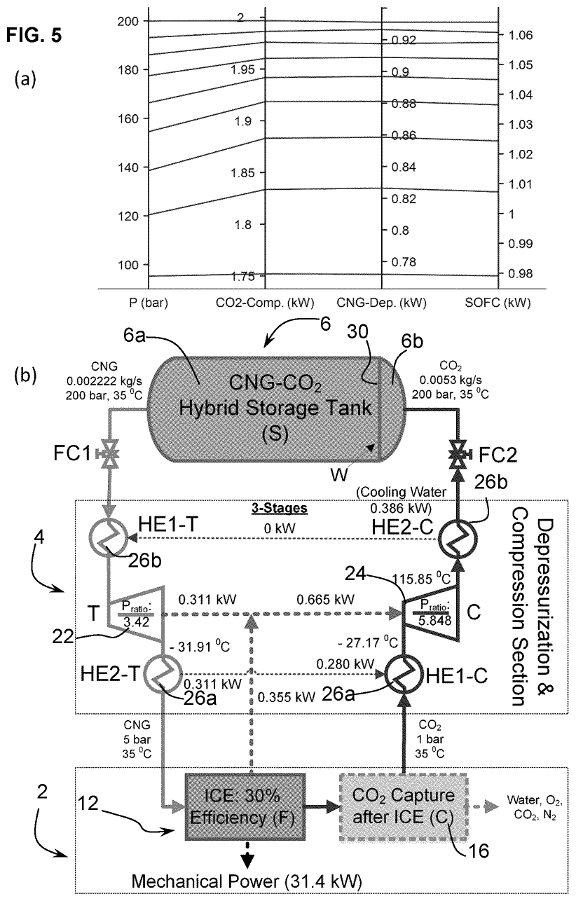

A CNG city-bus, with an internal combustion engine, consumes about 2.5 kg-CNG per km. Hence, the bus will consume about 80 kg of CNG to travel 200 km (Krelling and Badami, 2016). For a total travel time of 10 hours, the internal combustion engine will consume about 0.002222 kg-CNG/s. FIG. 5(a) presents power generated by CNG expansion (0.002222 kg/s) from different storage tank pressures to bars, and power required for compressing CO2 (0.0053 kg/s, 90% capture rate) from 1 bar to different storage tank pressures.

FIG. 5(a) also shows additional power supplied by the ICE system to compress CO2. The energy penalty for CO2 compression, in terms of extra CNG-used, is negligible compared to CNG used in the ICE. FIG. 5(b) presents flow-rates, temperatures, pressures and energy values corresponding to 200 bar storage tank pressure. These values will change with storage tank pressure (i.e., the consumption of CNG), and can be obtained using data provided in FIGS. 4 and 5(a).

In summary, embodiments of the invention advantageously provide CNG as an on-board energy source for an internal combustion engine or SOFC vehicle. The use of the CNG reservoir compatible with storing captured CO2 avoids volume and weight penalties for a separate storage tank for captured CO2. The mechanical power generated by CNG expansion is used to compress product CO2. The remaining CO2 compression power is supplied by the fuel conversion system. In case of a SOFC conversion system, more than 62% compression power can be supplied by CNG expansion, whereas, for an ICE conversion system, more than 44% compression power can be supplied by CNG expansion. The energy penalty for CO2 compression, in terms of extra CNG-used, is negligible compared to CNG-used in the fuel conversion system.

The on-board CO2 can directly be used to produce green methane using renewable electricity. The proposed energy transfer system (depressurization and compression section) can be used at the filling station or in the parking lot, where on-board CO2 has to be expanded for green natural gas production, and green natural gas has to be compressed to hybrid storage tank pressure.

### REFERENCES

1. Sharma S. and Maréchal F., Carbon Dioxide Capture from Internal Combustion Engine Exhaust Using Temperature Swing Adsorption, Frontiers in Energy Research 7, 2019.
2. Rogge M., Wollny S. and Sauer D. U., Fast charging battery buses for the electrification of urban public transport-A feasibility study focusing on charging infrastructure and energy storage requirements, Energies 8, pp. 4587-4606, 2015.
3. Scaling up the transition to electric mobility, Global EV Outlook 2019, IEA.
4. Dimitrova Z. and Maréchal F. Techno-economic design of hybrid electric vehicles and possibilities of the multi-objective optimization structure, Applied Energy 161, pp. 746-759, 2016.
5. Sharma S. and Maréchal F., Robust multi-objective optimization of solid oxide fuel cell gas turbine hybrid cycle and uncertainty analysis, J. Electrochemical Energy Conversion and Storage 15(4), 2018.
6. Iosifidou E. A., Codani P. and Kempton W., Measurement of power loss during electric vehicle charging and discharging, Energy 127, pp. 730-742, 2017.
7. Gao Z., Lin Z., Laclair T. J., Liu C., Li J. M., Birky A. K. and Ward J. Battery capacity and recharging needs for electric buses in city transit service, Energy 122, pp. 588-600, 2017.
8. Lajunen A. and Lipman T., Life cycle cost assessment and carbon dioxide emissions of diesel, natural gas, hybrid electric, fuel cell hybrid and electric transit buses, Energy 106, pp. 329-342, 2016.
9. Report on CNG cylinders for automotive vehicle applications, Product Development, Ashok Leyland Technical Centre, Chennai, 2012.
10. Krelling C. and Badami M. G., Operational and financial performance of Delhi's natural gas-fueled public bus transit fleet: A critical evaluation, Transport Policy, 2016.
11. Maréchal F. and Kalitventzeff B., Process integration: selection of the optimal utility system, Computers and Chemical Engineering 22, pp. 149-156, 1998.

List of references in the drawings:

CNG Power System 1
Fuel conversion system 2
Power unit 12, 14
Internal combustion engine (ICE) 12
Solid oxide fuel cell (SOFC) 14
CO2 capture unit 16
Water separator 18
Energy storage unit
Batteries 20
Energy transfer system 4 (depressurization and compression section)
CNG expansion turbine 22
CO2 compressor 24
Heat exchangers 26
First heat exchanger 26a
Second heat exchanger 26b
Storage tank 6
CNG section 6a
Entry/exit connection 28a
CO2 section 6b
Entry/exit connection 28b
Partition 30
Movable wall
membrane
Fuel circuit 8
Flow control valve FC1
CO2 circuit 10
Flow control valve FC2

1. CNG power system (1) comprising a storage tank, a fuel conversion system and an energy transfer system, wherein the storage tank is connected fluidically to the fuel conversion system via the energy transfer system, the fuel conversion system comprising a power unit using CNG as fuel and generating gas emissions comprising CO2, the fuel conversion system comprising a CO2 capture unit configured for separating out CO2 from the gas emissions, wherein the energy transfer system comprises a CNG expansion turbine mounted in a fuel circuit between the storage tank and fuel conversion system powered by expansion of the CNG flowing from the storage tank to the fuel conversion system, wherein the energy transfer system further comprises a CO2 compressor connected between the fuel conversion system and the storage tank along a CO2 circuit for compressing the CO2, wherein power for driving the CO2 compressor is supplied in part by power generated by the CNG expansion turbine.

2. System according to claim 1, wherein the storage tank comprises a CNG section in which CNG is stored and a CO2 section in which captured CO2 is stored, the CNG section separated from the CO2 section by a movable partition.

3. System according to claim 2, wherein the partition is a movable wall within the storage tank, or a deformable membrane substantially hermetically sealing the CNG section from the CO2 section.

4. System according to claim 1, wherein the energy transfer system further comprises heat exchangers configured for transferring heat from the CO2 circuit to the fuel circuit.

5. System according to claim 4, wherein the heat exchangers comprise at least a first heat exchanger coupled to the CO2 circuit upstream of the CO2 compressor and downstream of the CNG expansion turbine.

6. System according to claim 5, wherein the energy transfer system comprises a second heat exchanger connected upstream of the CNG expansion turbine and downstream of the CO2 compressor.

7. System according to claim 1, wherein the storage tank is connected to the fuel circuit via a flow control valve and to the CO2 circuit via a flow control valve.

8. System according to claim 1, wherein the power unit comprises an internal combustion engine.

9. System according to claim 1, wherein the fuel conversion system comprises a solid oxide fuel cell SOFC.

10. System according to claim 1, wherein the fuel conversion system comprises batteries.
